(19) United States
(12) Patent Application Publication
(10) Pub. No.: US 2022/0139360 A1
(43) Pub. Date: May 5, 2022

(54) Fulcrum Tremolo Spring Locking Claw and Claw Resonator Plate

(71) Applicant: Lance Robert McCormick, Chatsworth, CA (US)

(72) Inventor: Lance Robert McCormick, Chatsworth, CA (US)

(73) Assignee: Lance Robert McCormick, Chatsworth, CA (US)

(21) Appl. No.: 17/084,311

(22) Filed: Oct. 29, 2020

(51) Int. Cl. G10D 3/153; G10D 3/06; G10D 3/12; G10D 3/22; G10D 1/08; G10H 3/18

(52) U.S. Cl. CPC G10D 3/153; G10D 3/06; G10D 3/12; G10H 2220/461; G10D 1/085; G10H 3/18; G10D 3/22

(57) ABSTRACT

Sonic improvement for all stringed instruments that employ a fulcrum tremolo bridge system with back of instrument counter tensioning springs. The improvement is provided by securing springs to claw assembly, as well as securing claw assemble to a flat plate of material which is in turn secured to instrument body. The claw and resonator plate can be fabricated as two individual pieces then fastened together or as a combined one piece assemble that is then fastened to instrument body.

### FEDERALLY SPONSORED RESEARCH

Not Applicable

### SEQUENCE LISTING OF PROGRAM

Not Applicable

### FIELD OF INVENTION

This invention relates to a volume, sustain, and frequency response improvement for guitars and stringed musical instruments consisting of a body, neck, and plurality of strings under tension employing a fulcrum tremolo string bridge system.

### BACKGROUND OF INVENTION

Stringed musical instruments, such as the electric guitar, have featured an option since the 1950's called a tremolo. It is a fulcrum point string bridge located on instrument body face that allows performer to lower or raise the pitch of all strings simultaneously. The most widely employed type of fulcrum tremolo system generates the needed string counter tension via a plurality of springs located in a cavity on back of instrument body. One end of the plurality of springs is attached to the bottom portion of the bridge called the “block” and the other to a piece of flanged steel called the “claw”. The claw is secured to guitar body via two wood screws to the spring cavity wall opposite that of bridge block. The two screws allow for tension adjustment of Tremolo System. The drawback to current tremolo system is the lack of mechanical coupling strings have with instrument body. The screw heads and bridge fulcrum points alone fail to realize the vibrating strings full potential for sound wave transfer; there by attenuating the frequency response, amplitude, and sustain of sound waves resonating into instrument body and neck.

### SUMMARY OF INVENTION

These matters were initially addressed in my Fulcrum Tremolo Claw Lock Resonator U.S. Pat. No. 10,643,587 B1. Continued development on the principal system has yielded addition methods of improving frequency response, amplitude, and sustain of the vibrating string(s) into instrument body and neck.

The first improvement was realized in the development of a “spring locking claw”. By redesigning the current industry standard “claw” so that the flanged steel spring retaining posts are substituted by a compression generating spring retaining post screw assembly, that change instituted a instrument wide sonic improvement. In the standard flange metal claw design the tremolo system counter tensioning springs are simply hooked on to the, finger like, flange steel posts and secured in position via the tension generated by the instrument's strings, that method presents only minimal surface area at connection point for sound wave energy to be transferred between “springs” and “claw”, the “spring locking claw” design allows the “springs” to be compression coupled to the face of “claw” via screw assemble creating far more surface area between components for resonance coupling to occur. The added necessity of employing a material thick enough to be drilled and tapped for the screws to function as spring retaining posts increased the “claw” components general mass, that mass increase to instrument's core proved to be of added tonal benefit.

The second improvement was realized via a new fabrication method for the “Fulcrum Tremolo Claw Lock Resonator” U.S. Pat. No. 10,643,587 B1 in which the “resonator plate” and “claw” are constructed as a single piece. The needed tremolo system spring/string counter tensioning adjustments are still arrived at in the traditional way, via the two large “claw” retaining screws, located opposite side of tremolo spring cavity from “bridge block”. The marriage of “resonator plate” and “claw” allows for a simplified method of fabrication yet still achieves the sound wave energy coupling benefits present in the two piece “Claw Lock Resonator” fabrication method. A necessity was found in this new one piece design requiring “repositioned and elongated” mounting screw slots. Those mounting screw slot changes were needed to allow for adjustment “set up” of the tremolo system before securing the “Claw Resonator Plate” to spring cavity wood surface for maximum string resonance coupling into guitar body and neck.

### BRIEF DESCRIPTION OF THE DRAWINGS

FIG. 1 is a top view of spring counter tensioning cavity on back of guitar that employs a fulcrum tremolo system.

FIG. 2 is a side cut away view of an electric guitar employing a fulcrum tremolo spring bridge.

FIG. 3 is a top view of spring counter tensioning cavity on back of guitar that employs a fulcrum tremolo system.

### DISCLOSURE OF DETAILED DESCRIPTION OF THE PREFERRED EMBODIMENT

Other objects, features, and advantages will occur from the following description of a preferred embodiment and the accompanying drawings, in which:

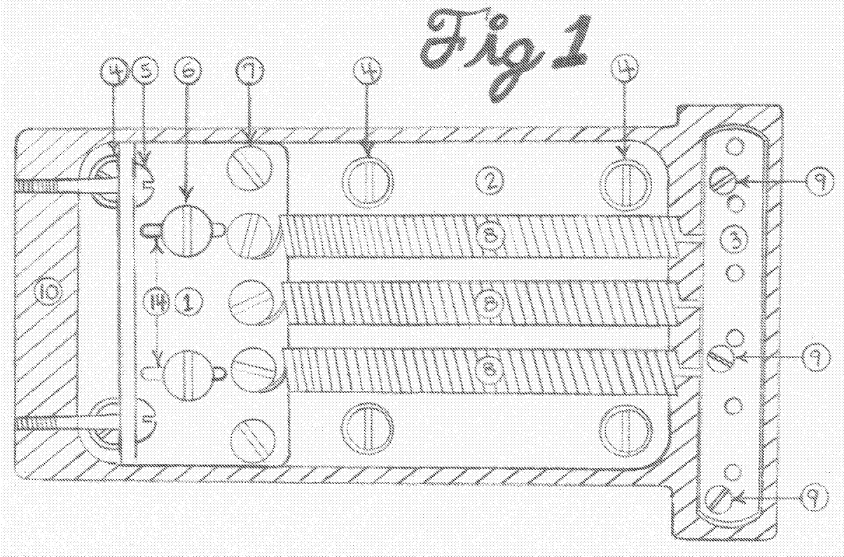

FIG. 1 demonstrates the Fulcrum Tremolo Spring Locking Claw 1, counter tensioning spring retaining post screw assembly 7, counter tensioning adjustment screws 5, resonator plate 2, mounting to body screws 4, claw to resonation plate bonding screws 6, claw to resonator plate bonding screw slots 14, fulcrum tremolo spring locking bridge block spring securing plate 3, mounting to bridge block screws 9, fulcrum tremolo counter tensioning springs 8, wood of guitar's counter tensioning spring cavity 10.

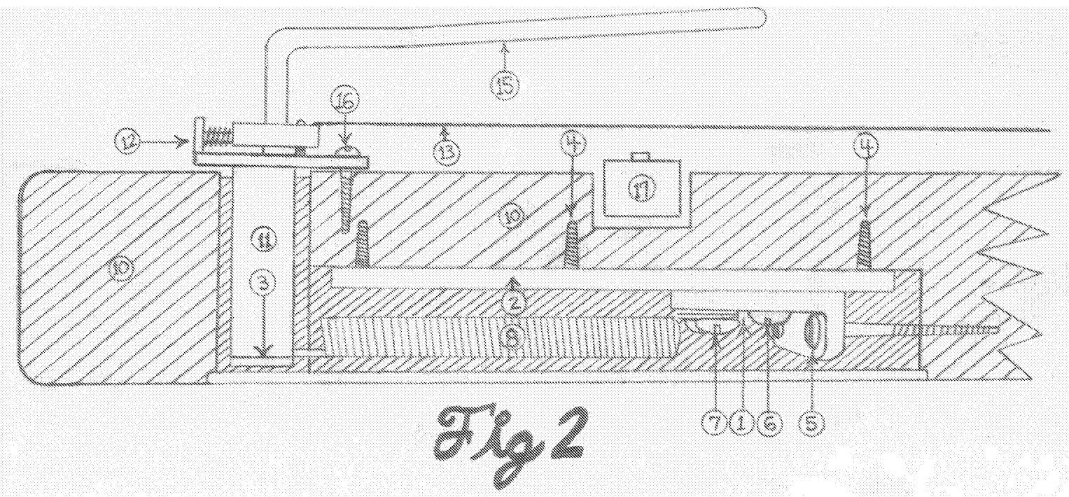

FIG. 2 demonstrates the wooden guitar body 10, the strings 13, the electromagnetic pickup 17, the arm to activate tremolo 15, bridge platter and string saddles 12, bridge mounting screws and fulcrum point 16, bridge block 11, fulcrum tremolo spring locking bridge block spring securing plate 3, spring securing plate screws 9, Fulcrum Tremolo Spring Locking Claw 1, counter tensioning spring retaining post screw assembly 7, resonation plate 2, mounting to body screws 4, claw to resonator plate bonding screws 6, counter tensioning adjustment screws 5, fulcrum tremolo counter tensioning springs 8.

Screw 7 is demonstrating the replacement of flanged steel claw spring retaining post. This modification allows for increased surface contact area between spring 8, and claw face 1, and is also secured under the compression provided by head of screw 7.

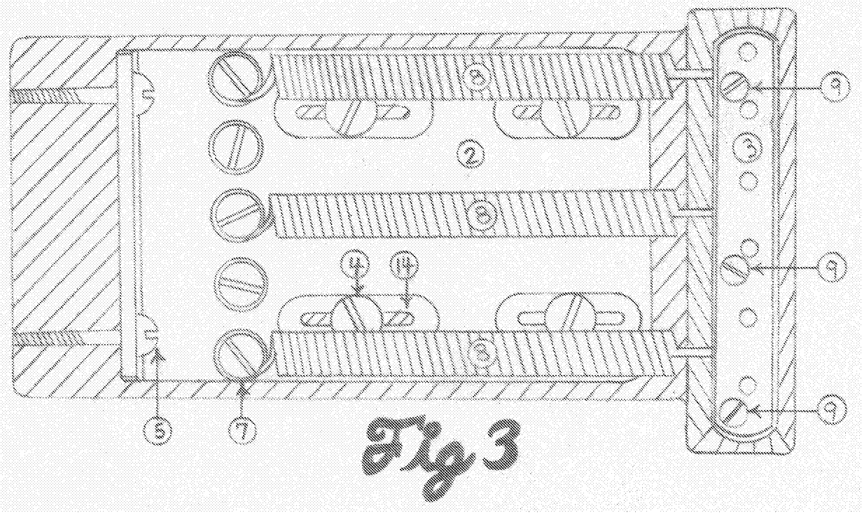

FIG. 3 demonstrates the Claw Resonator Plate 2, counter tensioning spring retaining post screw assembly 7, mounting to body screws 4, elongated mounting slot 14, counter tensioning adjustment screws 5, fulcrum tremolo counter tensioning springs 8, bridge block 11, bridge block spring securing plate 3, plate to bridge block fasteners 9, wood of spring cavity 10.

The modified form of Spring Locking Claw assemble provides slots 14, for receiving screws 6 which locks claw to resonator plate 2, spring retaining posts screw 7, for securing with compression spring 8 to claw 1.

FIG. 3 demonstrates the claw and resonator plate made in one piece, “Claw Resonator Plate” 2, counter tensioning spring retaining post screw assembly 7, counter tensioning adjustment screws 5, mounting to body screws 4, elongated mounting to body screw holes 14, spring securing plate 3, mounting to bridge block screws 9, bridge block 11, fulcrum tremolo counter tensioning springs 8, wood of tremolo spring cavity 10.

The Claw Resonator Plate 2, attaches to wooden spring cavity 10, via screws 4, through slots 14, and counter tension adjustment screw 5. Tremolo system counter tension springs 8, attaches to claw resonator plate 2, via screw 7.

The Fulcrum Tremolo Spring Locking Claw and Claw Resonator Plate can be retrofitted or original equipment on any stringed musical instrument with a fulcrum tremolo system that employs back of instrument body spring counter tensioning method most commonly used in electric guitar manufacturing. These items can be combined in a retro fit kit or sold as separate items to be employed individually. A complete two piece retro fit kit would include a Fulcrum Tremolo Spring Locking Claw 1, screws 6 and 7, Claw Lock Resonator plate 2, with mounting screws 4, or a single piece kit with Claw Resonator Plate combination and screws 7 and 4.

The instrument with the fulcrum tremolo string bridge system will be sonically improved by the addition of a Fulcrum Tremolo Spring Locking Claw or Claw Resonator Plate, these components provide expanded surface area and increased mass capable of transferring sound wave energy in the core of wooden string instrument more effectively and efficiently, so that amplitude, sustain, and frequency response are all improved. With enhanced frequency coupling of the fulcrum tremolo system to instrument core, the entire range of pitches and over tone harmonics the instrument can produce are audibly improved.

The presence of these inventions enhances low frequency response to the human ear, interpreted as a warmer sound, a richer sound, and a sound that needs less electronic processing to convey musical pleasure as perceived by our ears.

The securing of the counter tensioning springs of a fulcrum tremolo system to the Claw Resonator Plate or to a Spring Locking Claw and then to a Resonator Plate eliminates completely the potential of movement as found in the industry standard flanged metal claw, secured only by two screws, when tremolo is activated by player, thereby improving instrument tremolo systems tuning accuracy in returning to the non-pitch varied position of the tremolo bridge. Increasing the mass of the instrument body with the addition of a Spring Locking Claw or Claw Resonator Plate in the center or core of the instrument allows the instrument to more efficiently resonate sound energy outward to exterior edges of guitar body and neck.

1. A stringed musical instrument consisting of a solid resonating body having an elongated longitudinal inset cavity within at least the upper, rear boundary of said body; a neck; and a plurality of strings under tension that are counter tensioned by springs in a fulcrum tremolo string bridge system, the tremolo system comprising resonator block, where the inset cavity in the body receives the resonator block in a resonator block cavity portion of the inset cavity that extends through the body of instrument from the front and the resonator block is pivotally movable in the cavity portion; a spring retaining claw assemble comprising claws; tremolo tension springs mounted between the claws; tremolo tension springs mounted between the claw and the resonator block; with screws compression coupling springs to claw; and fasteners securing the spring retaining claw assembly of said system to a flat plate of a material which in turn is secured to instrument body.

2. The stringed musical instrumental instrument of claim 1, wherein the claw spring retaining post are fasteners; able to secure springs to face of claw; under compression creating a more efficient pathway for sound wave energy to transfer through and into instrument body and neck.

3. The stringed musical instrument of claim 1, wherein the claw and resonator plate are fabricated in one piece; with elongated slotted holes for the purpose of tremolo system adjustment and securing to instrument body.

4. The stringed musical instrument of claim 1, wherein the spring retaining claw assembly has an L-shape and the upright of L-shape has screw holes and the horizontal part has slotted screw holes and a row of five spring retaining screw holes, where a screw through the upright of L-shape mounts the spring retaining claw assemble to the solid body of the instrument and the horizontal part of the L-shape has screws through the slots into the flat plate of metal or non-metal material, with tremolo system springs secured to claw face via row of five screw holes.

5. The stringed musical instrument of claim 1, wherein the springs, Spring Locking Claw assembly and the flat plate are placed in the spring portion of the inset cavity, where the depth of the inset cavity is oriented into the solid body of the instrument from the rear of body, and there is a reduced thickness part of the body bounding the cavity which houses the instrument pick-ups on the front side and the elongated direction of the spring portion of the inset cavity is in the direction which the musical strings extend from fulcrum tremolo bridge.

6. The stringed musical instrument of claim 5, wherein the spring mount cavity portion of the inset cavity is bounded by inset walls on the sides and at the spring claw assembly mount wall which is opposite to the resonator block cavity portion, wherein screws extend from the upright of the L-shaped of the spring mount claw assembly into the spring claw assembly mount wall.

7. The stringed musical instrument of claim 6, wherein the flat sheet of metal and the L-shaped metal are fabricated from one piece of metal, positioned elongate in the spring length direction of the spring mount cavity portion of the inset cavity and extends to a position near the resonator block portion of the inset cavity, and where variations in length, width, thickness and material of the plate and L-shaped combined portions can tailor the sound of the stringed instrument.

8. The stringed musical instrument of claim 7, where the material of the plate is a magnetic material, the instrument is electrified by magnetic pickups and plate L-shape combination is mounted on the opposite side of the body.

9. The stringed musical instrument of claim 8, wherein the plate L-shaped combination is tapped for threads or slotted for tee nuts, where the machine screws attach alternately to tapped mounted on the opposite side of the body.

10. The stringed musical instrument of claim 9, wherein the plate L-shaped combination is tapped for threads or slotted for tee nuts, where the machine screws attach alternately to tapped threads or to tee nuts in the slots for tee nuts.

11. The stringed musical instrument of claim 10, wherein anchoring is achieved via screws or adhesive agent to the innermost surface of spring counter tension cavity, the surface that is at the back of the body in parallel to the instrument face.

12. The stringed musical instrument of claim 2, wherein anchoring of the L-shaped claw can be achieved via adhesive or screw slots on horizontal portion of said L-shaped claw directly to instrument body without the employment of metal plate, yielding a tonal instrument wide improvement.

13. A Fulcrum Tremolo Spring Locking Claw or Claw Resonator Plate can be incorporated into a retro fit kit or installed as individual items of improvement into a fulcrum tremolo spring mount, comprising an alternate spring claw assemble having springs that mount to the spring claw assemble mount wall of the spring mount cavity by the original spring claw screws, the spring claw assembly comprising pair of screw slots and five threaded spring retaining posts holes, a pair of machine screws for slots, five machine screws for spring retention posts, one machine screw for electrified guitar ground wire, a plate having a length and width to cove resonator block bottom with holes around the perimeter for fasteners to secure the tremolo system tensioning springs to said resonator block; under said tensioning springs a plate of metal just short of the length of spring cavity, a width half or more the width of the spring mount cavity, the plate comprising screw holes around the perimeter and two rows of threaded holes arranged for attachment by machine screw and aligned with slots of the alternate spring claw assembly; or optionally said plate and claw assemble fabricated from a single piece of metal with L-shape on end opposite that of resonator block functioning as both claw assembly and resonator plate; a set of mount screws for the holes around the perimeter of the metal plate that thread into the body of musical instrument; wherein the alternate spring claw assembly mounts by machine screw to the metal plate and the metal mounts to body of the string instrument; in the body fulcrum tremolo cavity; where variations in length, width, thickness and material of the metal plate can tailor the sound of the stringed instrument.

14. The Fulcrum Tremolo Spring Locking Claw and Claw Resonation Plate kit of claim 13, where the metal plate when mounted is opposite the electromagnetic pickups of the instrument and the material of the plate is magnetic metal material.

15. The stringed musical instrumental instrument of claim 7, wherein the flat plate is a metal or a non-metal, selected according to the desired sound modification characteristic.
